(19) United States
(12) Patent Application Publication
(10) Pub. No.: US 2023/0107407 A1
(43) Pub. Date: Apr. 6, 2023

(54) NON-HALIDE ZINC ADDITIVES FOR A SECONDARY ZINC HALIDE BATTERY

(71) Applicant: Eos Energy Technology Holdings, LLC, Wilmington, DE (US)

(72) Inventors: Rebecca Smith, Edison, NJ (US); Francis W. Richey, Edison, NJ (US); Lukas Fuchshofen, Edison, NJ (US)

(73) Assignee: Eos Energy Technology Holdings, LLC, Wilmington, DE (US)

(21) Appl. No.: 17/961,265

(22) Filed: Oct. 6, 2022

Related U.S. Application Data
(60) Provisional application No. 63/252,936, filed on Oct. 6, 2021.

(51) Int. Cl. H01M 10/36

(52) U.S. Cl. CPC H01M 10/365; H01M 2300/002

(57) ABSTRACT

Provided is an electrolyte for use in a secondary zinc halide electrochemical cell comprising: from about 20 wt. % to about 70 wt. % of a zinc halide of formula ZnY₂ or any combination of zinc halides of formula ZnY₂, wherein Y is a halide selected from fluoride, chloride, bromide, iodide, or any combination thereof; from about 10 wt. % to about 79 wt. % of H₂O; and from about 0.5 wt. % to about 20 wt. % of one or more zinc additives. The one or more zinc additives comprises a first zinc additive, wherein the first zinc additive is a salt that is not a zinc halide and comprises an anion with a van der Waals volume of greater than about 65 Å³. Also provided is a secondary zinc halide battery comprising at least one electrochemical cell comprising at least one bipolar electrode and the zinc halide electrolyte. Also provided is a secondary zinc halide battery comprising a zinc metal reservoir.

### CROSS-REFERENCE TO RELATED APPLICATIONS

This application claims the benefit of U.S. Provisional Application No. 63/252,936, filed Oct. 6, 2021, the disclosure of which is incorporated by reference herein in its entirety.

### TECHNICAL FIELD

Described herein are zinc additives for a secondary zinc halide battery.

### BACKGROUND

Zinc halide batteries were developed as devices for storing electrical energy. Traditional zinc halide batteries (e.g., zinc bromide batteries) employed bipolar electrodes disposed in a static, i.e., non-flowing, zinc bromide aqueous solution. The process of charging and discharging electrical current in a zinc halide battery is generally achieved through a reaction of redox couples like Zn²⁺/Zn(s) and X⁻/X₂ in zinc halide electrolyte. When the battery is charged with electrical current, the following chemical reactions occur:

### Zn²⁺+2e→Zn

2X⁻→X₂+2e⁻,
wherein X is a halogen (e.g., Cl, Br, or I). Conversely, when the battery discharges electrical current, the following chemical reactions occur:

### Zn→Zn²⁻+2e

### X₂2e→2X.

These zinc halide storage batteries were formed in a bipolar electrochemical cell stack, wherein each electrode comprises two poles, such that the anodic reaction occurs on one side of the electrode, and the cathodic reaction occurs on the opposite side of the same electrode. In this vein, bipolar electrodes were often configured as plates, and the cell stack was assembled to form a prismatic geometry. During charging and discharging of the bipolar battery, the electrode plates function as conductors for adjacent cells, i.e., each electrode plate serves as the anode for one cell and the cathode for the adjacent cell. In this prismatic battery geometry, the entire surface area of the electrode plate that separates adjacent electrochemical cells transfers current from cell to cell.

Accordingly, when a traditional bipolar zinc halide battery charges, zinc metal electrolytically plates on the anode side of the bipolar electrode plate, while molecular halogen species form at the cathode side of the electrode plate. And, when the battery discharges, the plated zinc metal is oxidized to free electrons that are conducted through the electrode plate and reduce the molecular halogen species to generate halide anions.

Zinc halide batteries require positively charged zinc ions and negatively charged halide ions to be available at the anode and cathode electrode, respectively, during the charging process. However, in concentrated aqueous electrolytes that are required for higher energy batteries, zinc thermodynamically prefers to form higher order negatively charged complexes with halides, such as, [ZnBr₃]⁻ and [ZnBr₄]²⁻. These negatively charged zinc species subsequently migrate to the cathode rather than anode during the charging process, which results in the anode becoming zinc starved during high zinc halide utilization. This limits the electrolyte utilization and requires battery cells to contain more zinc halide than is theoretically required if only positively charged zinc ions and negatively charged halide ions existed in solution, subsequently increasing the cost of the battery.

The speciation of the zinc bromide electrolyte has been studied with and without a zinc chloride electrolyte added. See, e.g., Rajarathnam, G. P., et al., “Chemical Speciation of Zinc-Halide Complexes in Zinc/Bromine Flow Battery Electrolytes,” J. Electrochemical Soc., 168, 070522 (2021). The proportion of four-ligand coordinated zinc halides, including [ZnBr₄]²⁻, [ZnCl₄]²⁻⁰ and mixed Cl/Br complexes, was found to increase with higher salt concentration. The authors did not propose a method by which to reduce the proportion of four-ligand coordinated zinc halide in electrolytes with a high concentration of zinc halide salts.

### BRIEF SUMMARY

The present disclosure describes an aqueous electrolyte for use in secondary zinc halide batteries that improves electrolyte utilization and improves coulombic efficiency of the zinc halide batteries. The present disclosure also describes the addition of a zinc metal reservoir to secondary zinc halide batteries to improve electrolyte utilization and improve coulombic efficiency of the zinc halide batteries.

In one aspect, the present disclosure describes an electrolyte for use in a secondary zinc halide electrochemical cell comprising: from about 20 wt. % to about 70 wt. % of a zinc halide of formula ZnY₂ or any combination of zinc halides of formula ZnY₂, wherein Y is a halide selected from fluoride, chloride, bromide, iodide, or any combination thereof; from about 10 wt. % to about 79 wt. % of H₂O; and from about 0.5 wt. % to about 20 wt. % of one or more zinc additives. The one or more zinc additives comprises a first zinc additive, wherein the first zinc additive is a salt that is not a zinc halide and comprises an anion with a van der Waals volume of greater than about 65 Å³.

In some embodiments, the electrolyte comprises from about 0.5 wt. % to about 3 wt. % of the first zinc additive. In some embodiments, a molar ratio of total zinc ion to halide ion in the electrolyte is from about 1:2 to about 1:3.

In some embodiments, the electrolyte comprises from about 0.5 wt. % to about 20 wt. % of the first zinc additive. In some embodiments, a molar ratio of total zinc ion to halide ion in the electrolyte is from about 1:1 to about 1:2.5.

In some embodiments, the one or more zinc additives further comprises a second zinc additive, wherein the second zinc additive is a salt that is not a zinc halide and comprises an anion with a van der Waals volume of smaller than about 65 Å³. In some embodiments, the electrolyte comprises from about 0.5 wt. % to about 15 wt. % of the second zinc additive.

In some embodiments, the first zinc additive is zinc trifluoromethanesulfonate, zinc perfluorobutanesulfonate, zinc bis(trifluoromethane)sulfonimide, zinc methanosulfonate, zinc p-toluenesulfonate, zinc hexafluorophosphate, zinc tetrakis[3,5-bis(trifluoromethyl)phenyl]borate, or any combination thereof.

In some embodiments, the electrolyte further comprises from about 0.5 wt. % to about 15 wt. % of KBr and from about 0.5 wt. % to about 15 wt. % of KCl.

In some embodiments, the electrolyte further comprises from about 0.05 wt. % to about 20 wt. % of one or more quaternary ammonium agents. Each quaternary ammonium agent is independently selected from a quaternary ammonium agent having a formula N⁺(R¹)(R²)(R³)(R⁴)X⁻, wherein R¹ is hydrogen or an alkyl group, R², R³, and R⁴ are each independently an alkyl group that is same or different from R¹, and X⁻ is chloride or bromide. In some embodiments, the one or more quaternary ammonium agents comprises a first quaternary ammonium agent with a concentration from about 0.05 wt. % to about 20 wt. %.

In some embodiments, the first quaternary ammonium agent is selected from a tetra-C₁₋₆ alkyl ammonium chloride or a tetra-C₁₋₆ alkyl ammonium bromide. In some embodiments, the first quaternary ammonium agent is tetramethylammonium chloride, tetraethylammonium chloride, tetrapropylammonium chloride, tetrabutylammonium chloride, tetramethylammonium bromide, tetraethylammonium bromide, tetrapropylammonium bromide, or tetrabutylammonium bromide.

In some embodiments, the one or more quaternary ammonium agents further comprises a second quaternary ammonium agent. In some embodiments, the second quaternary ammonium agent has a formula N⁺(R¹)(R²)(R³)(R⁴)X⁻, wherein R¹ is hydrogen or an alkyl group, R², R³, and R⁴ are each independently an alkyl group that is same or different from R¹, and X⁻ is chloride or bromide. In some embodiments, the concentration of the second quaternary ammonium agent is from about 0.05 wt. % to about 20 wt. %.

In some embodiments, the second quaternary ammonium agent is a chloride or bromide of trimethylethylammonium, trimethyl propylammonium, trimethylbutylammonium, triethylmethylammonium, triethylpropylammonium, triethylbutylammonium, tripropylmethylammonium, tripropylethylammonium, or tripropylbutylammonium.

In some embodiments, the electrolyte further comprises from about 0.2 wt. % to about 2.5 wt. % of DME-PEG. In some embodiments, the electrolyte comprises DME-PEG with a number average molecular weight of about 1000 amu, DME-PEG with a number average molecular weight of about 2000 amu, or a combination thereof.

In some embodiments, the electrolyte further comprises from about 0.25 wt. % to about 5 wt. % of a glycol, wherein the glycol is ethylene glycol, propylene glycol, 1,3-butylene glycol, 1,4-butylene glycol, neopentyl glycol, hexalene glycol, or any combination thereof.

In some embodiments, the electrolyte further comprises from about 0.5 wt. % to about 10 wt. % of a glyme, wherein the glyme is monoglyme, diglyme, triglyme, tetraglyme, pentaglyme, hexaglyme, or any combination thereof.

In some embodiments, the electrolyte further comprises less than 1 wt. % of one or more additives selected from Sn, In, Ga, Al, Tl, Bi, Pb, Sb, Ag, Mn, Fe, or any combination thereof.

In some embodiments, the electrolyte further comprises from 0.1 wt. % to 2 wt. % of acetic acid, sodium acetate, potassium acetate, or any combination thereof.

In some embodiments, the electrolyte is used in a static secondary zinc halide battery.

In some embodiments, the electrolyte is used in a flow secondary zinc halide battery.

In some embodiments, a zinc halide utilization in the electrolyte of the secondary zinc halide electrochemical cell is increased by about 5% to about 40% compared to an equivalent electrolyte in a secondary zinc halide electrochemical cell without the one or more zinc additives.

Another aspect of the present disclosure describes a secondary zinc halide battery comprising: at least one electrochemical cell comprising at least one bipolar electrode and a zinc halide electrolyte. The bipolar electrode comprises a bipolar electrode plate having an anode surface on one side of the bipolar electrode plate and a cathode surface on another side of the bipolar electrode plate that is opposite the anode surface. The zinc halide electrolyte is in contact with the bipolar electrode plate. The zinc halide electrolyte is as described herein.

In some embodiments, the zinc halide electrolyte comprises: from about 20 wt. % to about 70 wt. % of a zinc halide of formula ZnY₂ or any combination of zinc halides of formula ZnY₂, wherein Y is a halide selected from fluoride, chloride, bromide, iodide, or any combination thereof; from about 10 wt. % to about 79 wt. % of H₂O; and from about 0.5 wt. % to about 20 wt. % of one or more zinc additives. The one or more zinc additives comprises a first zinc additive, wherein the first zinc additive is a salt that is not a zinc halide and comprises an anion with a van der Waals volume of greater than about 65 Å³.

In some embodiments, the secondary zinc halide battery is a static secondary zinc halide battery.

In some embodiments, the secondary zinc halide battery is a flow secondary zinc halide battery.

In some embodiments, a zinc halide utilization in the electrolyte of each of the at least one electrochemical cell of the secondary zinc halide battery is increased by about 5% to about 40% compared to an equivalent electrolyte in an electrochemical cell of a secondary zinc halide battery without one or more zinc additives.

In some embodiments, the secondary zinc halide battery further comprises a cathode assembly disposed on the cathode surface of the bipolar electrode plate.

In some embodiments, the cathode assembly comprises a carbon material affixed to the surface of the bipolar electrode plate using an adhesive layer.

In some embodiments, the secondary zinc halide battery further comprises two terminal electrochemical cells, wherein each terminal electrochemical cell comprises a bipolar electrode, a terminal assembly, and the zinc halide electrolyte.

Yet another aspect of the present disclosure describes a secondary zinc halide battery comprising a zinc metal reservoir. The secondary zinc halide battery also comprises: at least one electrochemical cell comprising at least one bipolar electrode and a zinc halide electrolyte. The bipolar electrode comprises a bipolar electrode plate having an anode surface on one side of the bipolar electrode plate and a cathode surface on another side of the bipolar electrode plate that is opposite the anode surface. The zinc halide electrolyte is in contact with the bipolar electrode plate. The zinc halide electrolyte is either the zinc halide electrolyte described herein or a zinc halide electrolyte without the one or more zinc additives described herein.

In some embodiments, the zinc metal reservoir is in the at least one electrochemical cell and is in contact with the electrolyte. In some embodiments, the zinc metal reservoir is also in contact with the anode of the at least one electrochemical cell. However, zinc metal reservoir is not in contact with the cathode of the at least one electrochemical cell.

In some embodiments, the zinc metal reservoir is made up of zinc metal that is in the form of a powder, a granule, a foil, a sheet, a wire, or shavings.

### BRIEF DESCRIPTION OF DRAWINGS

These and other features, aspects, and advantages of the present disclosure will become better understood when the following detailed description is read with reference to the accompanying drawings.

FIG. 1 shows an exploded view of an electrochemical cell according to an embodiment of the present disclosure.

FIG. 2 is a side view of a battery according to an embodiment in the present disclosure.

FIG. 3 is an exploded view of the battery of FIG. 2.

FIG. 4 is an exploded view of a terminal assembly for use in the battery of FIG. 2.

FIG. 5 is a front view of a battery frame member for use in the battery of FIG. 2.

FIG. 6 shows representative average coulombic efficiency (%) as a function of zinc bromide utilization based on charge (%) for electrolyte with and without zinc additives according to embodiments in the present disclosure.

FIG. 7 shows representative [ZnBr₄]²⁻ peak height ratios (%) measured by Raman spectroscopy as a function of zinc bromide concentration (M) for electrolyte with and without zinc additives according to embodiments in the present disclosure.

### DETAILED DESCRIPTION

Embodiments of the present disclosure are described in detail with reference to the drawing figures wherein like reference numerals identify similar or identical elements. It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

### I. DEFINITIONS

As used herein, the term “electrochemical cell” or “cell” are used interchangeably to refer to a device capable of either generating electrical energy from chemical reactions or facilitating chemical reactions through the introduction of electrical energy. An electrochemical cell may be a bipolar electrochemical cell or a terminal electrochemical cell.

As used herein, the term “battery” encompasses electrical storage devices comprising at least one electrochemical cell. For example, a battery may be comprised of about 10 to 50 electrochemical cells in series. A “secondary battery” is rechargeable, whereas a “primary battery” is not rechargeable. For secondary batteries of the present disclosure, a battery anode is designated as the positive electrode during discharge, and as the negative electrode during charge.

As used herein, an “electrolyte” refers to a substance that behaves as an electrically conductive medium. For example, the electrolyte facilitates the mobilization of electrons and cations in the cell. Electrolytes include mixtures of materials such as aqueous solutions of metal halide salts (e.g., ZnBr₂, ZnCl₂, or the like).

As used herein, the term “electrode” refers to an electrical conductor used to make contact with a nonmetallic part of a circuit (e.g., a semiconductor, an electrolyte, or a vacuum). An electrode may also refer to either an anode or a cathode.

As used herein, the term “anode” refers to the negative electrode from which electrons flow during the discharging phase in the battery. The anode is also the electrode that undergoes chemical oxidation during the discharging phase. However, in secondary, or rechargeable, cells, the anode is the electrode that undergoes chemical reduction during the cell's charging phase. Anodes are formed from electrically conductive or semiconductive materials, e.g., metals (e.g., titanium or TiC coated titanium), metal oxides, metal alloys, metal composites, semiconductors, or the like.

As used herein, the term “cathode” refers to the positive electrode into which electrons flow during the discharging phase in the battery. The cathode is also the electrode that undergoes chemical reduction during the discharging phase. However, in secondary or rechargeable cells, the cathode is the electrode that undergoes chemical oxidation during the cell's charging phase. Cathodes are formed from electrically conductive or semiconductive materials, e.g., metals, metal oxides, metal alloys, metal composites, semiconductors, or the like.

As used herein, the term “bipolar electrode” refers to an electrode that functions as the anode of one cell and the cathode of another cell. For example, in a battery, a bipolar electrode functions as an anode in one cell and functions as a cathode in an immediately adjacent cell. In some examples, a bipolar electrode comprises two surfaces, a cathode surface and an anode surface, wherein the two surfaces are connected by a conductive material. For instance, a bipolar electrode plate may have opposing surfaces wherein one surface is the anode surface, the other surface is the cathode surface, and the conductive material is the thickness of the plate between the opposing surfaces.

As used herein, the term “halide” refers to a binary compound of a halogen with another element or radical that is less electronegative (or more electropositive) than the halogen, to make a fluoride, chloride, bromide, iodide, or astatide compound.

As used herein, the term “halogen” refers to any of the elements fluorine, chlorine, bromine, iodine, and astatine, occupying group VIIA (17) of the periodic table. Halogens are reactive nonmetallic elements that form strongly acidic compounds with hydrogen, from which simple salts can be made.

As used herein, the term “anion” refers to any chemical entity having one or more permanent negative charges. Examples of anions include, but are not limited to fluoride, chloride, bromide, iodide, arsenate, phosphate, arsenite, hydrogen phosphate, dihydrogen phosphate, sulfate, nitrate, hydrogen sulfate, nitrite, thiosulfate, sulfite, perchlorate, iodate, chlorate, bromate, chlorite, hypochlorite, hypobromite, carbonate, chromate, hydrogen carbonate (bicarbonate), dichromate, acetate, formate, cyanide, amide, cyanate, peroxide, thiocyanate, oxalate, hydroxide, and permanganate.

As used herein, a “titanium material” may include, but is not limited to, titanium (in any oxidation state), TiC, alloys of TiC such as TiCₓM (where x is 0, 1, 2, 3, or 4 and M is a metal), titanium carbohyrides, non-stoichiometric titanium-carbon compounds, and combinations thereof.

As used herein, “titanium carbide” is used interchangeably with “titanium carbide material” and includes, but is not limited to TiC, alloys of TiC such as TiCₓM (where x is 0, 1, 2, 3, or 4 and M is a metal), titanium carbohydrides, non-stoichiometric titanium-carbon compounds, and combinations thereof.

As used herein, the term “zinc metal” refers to elemental zinc, also commonly known as Zn(0) or Zn⁰.

For purposes of this disclosure, the term “dimethyl ether poly(ethylene glycol)”, “DME-PEG”, is used interchangeably to refer to a polymer having the structure

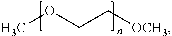

where n is an integer. DME-PEG 1000 refers to a DME-PEG polymer having a number average molecular weight (Mₙ) about 1000 amu, and DME-PEG 2000 refers to a DME-PEG polymer having a number average molecular weight (Mₙ) of about 2000 amu.

As used herein, the term “dimethyl ether” refers to an organic compound having the formula CH₃OCH₃.

As used herein, the term “aggregate concentration” refers to the sum total concentration (e.g., wt. %) of each constituent of a class of ingredients or a class of agents (e.g., quaternary ammonium agents). In one example, the aggregate concentration of one or more quaternary ammonium agents in an electrolyte is the sum total of the concentrations (e.g., weight percents) of each constituent quaternary ammonium agent present in the electrolyte. Thus, if the electrolyte has three quaternary ammonium agents, the aggregate concentration of the three quaternary ammonium agents is the sum of the concentrations for each of the three quaternary ammonium agents present in the electrolyte. And, if the electrolyte has only one quaternary ammonium agent, the aggregate concentration of the quaternary ammonium agents is simply the concentration of the single quaternary ammonium agent present in the electrolyte.

As used herein, the term “alcohol” refers to any organic compound whose molecule contains one or more hydroxyl groups attached to a carbon atom. Examples of alcohols include methanol, ethanol, 1-propanol (i.e., n-propanol), 2-propanol (i.e., iso-propanol), 1-butanol (i.e., n-butanol), sec-butanol, iso-butanol, tert-butanol, 1-pentanol, or any combination thereof.

As used herein, the term “hydroxyl group” refers to an —OH group.

As used herein, the term “glycol” refers to any of a class of organic compounds belonging to the alcohol family. In the molecule of a glycol, two hydroxyl (—OH) groups are attached to different carbon atoms. Examples of glycols include C₁₋₁₀ glycols including ethylene glycol, propylene glycol, 1,3-butylene glycol, 1,4-butylene glycol, neopentyl glycol, hexalene glycol, or any combination thereof. Other examples of glycols include substituted ethylene and substituted propylene glycols.

As used herein, the term “weight percent” and its abbreviation wt. %” or “wt %” are used interchangeably to refer to the product of 100 times the quotient of mass of one or more components divided by total mass of a mixture or product containing said component:

wt %=100%×(mass of component(s)/total mass)

When referring to the concentration of components or ingredients for electrolytes, as described herein, wt. % or wt % is based on the total weight of the electrolyte.

As used herein, the term “quaternary ammonium agent” refers to any compound, salt, or material comprising a quaternary nitrogen atom. Non-limiting examples of quaternary ammonium agents include, for example, tetra-alkylammonium halides (e.g., tetramethylammonium bromide, tetramethylammonium chloride, tetraethylammonium bromide, tetraethylammonium chloride, alkyl-substituted pyridinium halides, alkyl-substituted morpholinium halides, combinations thereof or the like), heterocyclic ammonium halides (e.g., alkyl-substituted pyrrolidinium halide (e.g., N-methyl-N-ethylpyrrolidinium halide or N-ethyl-N-methylpyrrolidinium halide), alkyl-substituted pyridinium halides, alkyl-substituted morpholinium halides, viologens having at least one quaternary nitrogen atom, combinations thereof, or the like), or any combination thereof. Tetra-alkylammonium halides may be symmetrically substituted or asymmetrically substituted with respect to the substituents of the quaternary nitrogen atom.

As used herein, the term “viologen” refers to any bipyridinium derivative of 4-4′-bipyridine.

As used herein, the term “ammonium bromide complexing agent” refers to any compound, salt, or material comprising a quaternary nitrogen atom, wherein the quaternary nitrogen atom is not part of an imidazolium, pyridinium, pyrrolidinium, morpholinium, or phosphonium moiety. Examples of ammonium bromide complexing agents include: tetraethylammonium bromide, trimethylpropylammonium bromide, dodecyltrimethylammonium bromide, cetyltriethylammonium bromide, and hexyltrimethylammonium bromide.

As used herein, the term “imidazolium bromide complexing agent” refers to any compound, salt, or material comprising a quaternary nitrogen atom, wherein the quaternary nitrogen atom is part of an imidazolium moiety. Examples of imidazolium bromide complexing agents include: 1-ethyl-3-methylimidazolium bromide, 1-butyl-3-methylimidazoliium bromide, 1-ethyl-2,3-dimethylimidazolium bromide, 1-decyl-3-methylimidazolium bromide, 1-butyl-2,3-dimethylimidazolium bromide, 1-methyl-3-octylimidazollium bromide, and 1-methyl-3-hexylimidazolium bromide.

As used herein, the term “pyridinium bromide complexing agent” refers to any compound, salt, or material comprising a quaternary nitrogen atom, wherein the quaternary nitrogen atom is part of a pyridinium moiety. Examples of pyridinium bromide complexing agents include: 1-ethyl-2-methylpyridinium bromide, 1-ethyl-3-methylpyridinium bromide, 1-ethyl-4-methylpyridinium bromide, 1-butyl-3-methylpyridinium bromide, 1-butyl-3-methylpyridinium bromide, 1-butyl-4-methylpyridinium bromide, and 1-hexylpyridinium bromide.

As used herein, the term “pyrrolidinium bromide complexing agent” refers to any compound, salt, or material comprising a quaternary nitrogen atom, wherein the quaternary nitrogen atom is part of a pyrrolidinium moiety. An example of a pyrrolidinium bromide complexing agent is 1-butyl-1-methylpyrrolidinium bromide.

As used herein, the term “morpholinium bromide complexing agent” refers to any compound, salt, or material comprising a quaternary nitrogen atom, wherein the quaternary nitrogen atom is part of a morpholinium moiety. An example of a morpholinium bromide complexing agent is N-ethyl-N-methylmorpholinium bromide.

As used herein, the term “phosphonium bromide complexing agent” refers to any compound, salt, or material comprising a quaternary phosphonium atom. An example of a phosphonium bromide complexing agent is tetraethylphosphonium bromide.

As used herein, the term “crown ether” refers to a cyclic chemical compound consisting of a ring containing at least three ether groups. Examples of crown ethers include 12-crown-4, 15-crown-5, 18-crown-6, dibenzo-18-crown-6, and diaza-18-crown-6.

As used herein, an “alkyl” group refers to a saturated aliphatic hydrocarbon group containing 1-20 (e.g., 1-16, 1-12, 1-8, 1-6, or 1-4) carbon atoms. An alkyl group can be straight or branched. Examples of alkyl groups include, but are not limited to, methyl, ethyl, propyl, isopropyl, butyl, isobutyl, sec-butyl, tert-butyl, pentyl, hexyl, heptyl, 2-ethylhexyl, octyl, nonyl, decyl, dodecyl, and cetyl.

As used herein, an “aryl” group used alone or as part of a larger moiety as in “aralkyl”, “aralkoxy”, or “aryloxyalkyl” refers to monocyclic (e.g., phenyl); bicyclic (e.g., indenyl, naphthalenyl, tetrahydronaphthyl, tetrahydroindenyl); tricyclic (e.g., fluorenyl, tetrahydrofluorenyl, anthracenyl, or tetrahydroanthracenyl); or a benzofused group having 3 rings. For example, a benzofused group includes phenyl fused with two or more C₄₋₈ carbocyclic moieties. An aryl is optionally substituted with one or more substituents including aliphatic (e.g., alkyl, alkenyl, or alkynyl); cycloalkyl; (cycloalkyl)alkyl; heterocycloalkyl; (heterocycloalkyl)alkyl; aryl; heteroaryl; alkoxy; cycloalkyloxy; heterocycloalkyloxy; aryloxy; heteroaryloxy; aralkyloxy; heteroaralkyloxy; aroyl; heteroaroyl; amino; aminoalkyl; nitro; carboxy; carbonyl (e.g., alkoxycarbonyl, alkylcarbonyl, aminocarbonyl, (alkylamino)alkylaminocarbonyl, arylaminocarbonyl, heteroarylaminocarbonyl; or sulfonylcarbonyl); aryalkylcarbonyloxy; sulfonyl (e.g., alkylsulfonyl or aminosulfonyl); sulfinyl (e.g., alkylsulfinyl); sulfanyl (e.g., alkylsulfanyl); cyano; halo; hydroxyl; acyl; mercapto; sulfoxy; urea; thiourea; sulfamoyl; sulfamide; oxo; or carbamoyl. Alternatively, an aryl may be unsubstituted.

Examples of substituted aryls include haloaryl, alkoxycarbonylaryl, alkylaminoalkylaminocarbonylaryl, p,m-dihaloaryl, p-amino-p-alkoxycarbonylaryl, m-amino-m-cyanoaryl, aminoaryl, alkylcarbonylaminoaryl, cyanoalkylaryl, alkoxyaryl, aminosulfonylaryl, alkylsulfonylaryl, aminoaryl, p-halo-m-aminoaryl, cyanoaryl, hydroxyalkylaryl, alkoxyalkylaryl, hydroxyaryl, carboxyalkylaryl, dialkylaminoalkylaryl, m-heterocycloaliphatic-o-alkylaryl, heteroarylaminocarbonylaryl, nitroalkylaryl, alkylsulfonylaminoalkylaryl, heterocycloaliphaticcarbonylaryl, alkylsulfonylalkylaryl, cyanoalkylaryl, heterocycloaliphaticcarbonylaryl, alkylcarbonylaminoaryl, hydroxyalkylaryl, alkylcarbonylaryl, aminocarbonylaryl, alkylsulfonylaminoaryl, dialkylaminoaryl, alkylaryl, and trihaloalkylaryl.

As used herein, an “aralkyl” group refers to an alkyl group (e.g., a C₁₋₄ alkyl group) that is substituted with an aryl group. Both “alkyl” and “aryl” are defined herein. An example of an aralkyl group is benzyl. A “heteroaralkyl” group refers to an alkyl group that is substituted with a heteroaryl.

As used herein, a “cycloalkyl” group refers to a saturated carbocyclic mono-, bi-, or tri-, or multicyclic (fused or bridged) ring of 3-10 (e.g., 5-10) carbon atoms. Without limitation, examples of monocyclic cycloalkyl groups include cyclopropyl, cyclobutyl, cyclopentyl, cyclohexyl, cycloheptyl, or the like. Without limitation, examples of bicyclic cycloalkyl groups include octahydro-indenyl, decahydro-naphthyl, bicyclo[3.2.1]octyl, bicyclo[2.2.2]octyl, bicyclo[3.3.1]nonyl, bicyclo[3.3.2.]decyl, bicyclo[2.2.2]octyl, bicycle[2.2.1]heptanyl, bicycle[3.1.1]heptanyl, or the like. Without limitation, multicyclic groups include adamantyl, cubyl, norbornyl, or the like. Cycloalkyl rings can be optionally substituted at any chemically viable ring position.

As used herein, a “heterocycloalkyl” group refers to a 3-10 membered mono or bicyclic (fused or bridged) (e.g., 5 to 10 membered mono or bicyclic) saturated ring structure, in which one or more of the ring atoms is a heteroatom (e.g., N, O, S, or combinations thereof). Examples of a heterocycloalkyl group include optionally substituted piperidyl, piperazyl, tetrahydropyranyl, tetrahydrofuryl, 1,4-dioxolanyl, 1,4-dithianyl, 1,3-dioxolanyl, oxazolidyl, isoxazolidyl, morpholinyl, thiomorpholyl, octahydro-benzofuryl, octahydro-chromenyl, octahydro-thiochromenyl, octahydro-indolyl, octahydro-pyrindinyl, decahydro-quinolinyl, octahydro-benzo[b]thiopheneyl, 2-oxa-bicyclo[2.2.2]octyl, 1-aza-bicyclo[2.2.2]octyl, 3-aza-bicyclo[3.2.1]octanyl, 2,6-dioxa-tricyclo[3.3.1.0^{3,7}]nonyl, tropane. A monocyclic heterocycloalkyl group may be fused with a phenyl moiety such as tetrahydroisoquinoline. Heterocycloalkyl ring structures can be optionally substituted at any chemically viable position on the ring or rings.

A “heteroaryl” group, as used herein, refers to a monocyclic, bicyclic, or tricyclic ring structure having 4 to 15 ring atoms wherein one or more of the ring atoms is a heteroatom (e.g., N, O, S, or combinations thereof) and wherein one or more rings of the bicyclic or tricyclic ring structure is aromatic. A heteroaryl group includes a benzo fused ring system having 2 to 3 rings. For example, a benzo fused group includes benzo fused with one or two C₄₋₈ heterocyclic moieties (e.g., indolizyl, indolyl, isoindolyl, 3H-indolyl, indolinyl, benzo[b]furyl, benzo[b]thiophenyl, quinolinyl, or isoquinolinyl). Some examples of heteroaryl are azetidinyl, pyridyl, 1H-indazolyl, furyl, pyrrolyl, thienyl, thiazolyl, oxazolyl, imidazolyl, tetrazolyl, benzofuryl, isoquinolinyl, benzthiazolyl, xanthene, thioxanthene, phenothiazine, dihydroindole, benzo[1,3]dioxole, benzo[b]furyl, benzo[b]thiophenyl, indazolyl, benzimidazolyl, benzthiazolyl, puryl, cinnolyl, quinolyl, quinazolyl, cinnolyl, phthalazyl, quinazolyl, quinoxalyl, isoquinolyl, 4H-quinolizyl, benzo-1,2,5-thiadiazolyl, or 1,8-naphthyridyl. Heteroaryls also include bipyridine compounds.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” comprises any and all combinations of one or more of the associated listed items.

The terms, upper, lower, above, beneath, right, left, etc. may be used herein to describe the position of various elements with relation to other elements. These terms represent the position of elements in an example configuration. However, it will be apparent to one skilled in the art that the battery frame member may be rotated in space without departing from the present disclosure and thus, these terms should not be used to limit the scope of the present disclosure.

As used herein, “over-molding” refers to a process of adding an additional layer of material by injection molding over an already existing piece or part.

As used herein, “plurality” refers to two or more of the elements being described. In some embodiments, plurality refers to three or more, four or more, or five or more of the elements being described.

As used herein, “chemically compatible” refers to a material that does not interfere with the chemistry of an electrochemical cell in a way that meaningfully negatively impacts the performance of the electrochemical cell. The chemically compatible material is chemically compatible with electrolyte (e.g., zinc halide electrolyte, alkaline electrolyte) and anode and cathode materials.

As used herein, “chemically inert” refers to a material that does not chemically react in any meaningful way with the electrolyte, anode, or cathode of an electrochemical cell.

As used herein, “substantially rectangular” refers to shapes that, while not precisely rectangular, have four sides and, when viewed, have a rectangular appearance.

As used herein, “substantially parallel” means the surfaces of the objects that are substantially parallel are not more than 2° (two degrees) from being parallel across the length of the surfaces.

### II. ELECTROCHEMICAL CELL AND BATTERY

In one aspect, the present disclosure provides an electrolyte for use in a secondary zinc halide electrochemical cell and battery. In another aspect, the present disclosure provides a secondary zinc halide battery comprising the electrolyte. The secondary zinc halide battery may be a static (non-flowing) secondary zinc halide battery or a flow secondary zinc halide battery. In yet another aspect, the present disclosure provides a secondary zinc halide battery comprising a zinc metal reservoir. The electrolyte in the secondary zinc halide battery is either the electrolyte with the one or more zinc additives described herein or an electrolyte without the one or more zinc additives described herein.

### A. Electrolyte

The present disclosure provides an electrolyte that is useful in flowing or non-flowing (i.e., static) secondary zinc halide electrochemical cells and batteries. In these electrochemical cells and batteries, zinc halide (e.g., zinc bromide, zinc chloride, or any combination of the two) present in the electrolyte acts as the electrochemically active material. These electrochemical cells and batteries are described below.

The electrolyte of the present disclosure is an aqueous zinc halide electrolyte that is in contact with a bipolar electrode plate of an at least one bipolar electrode of the electrochemical cell. In some embodiments, the electrolyte is interposed between an inner surface of a terminal endplate, a cathode assembly, a front surface of the bipolar electrode, and if present, interior surfaces of a frame. In some embodiments, the secondary zinc halide battery is a flow secondary zinc halide battery, where the electrolyte flows through all the bipolar cells. In other embodiments, the secondary zinc halide battery is a static secondary zinc halide battery, where the electrolyte is mechanically isolated in each bipolar cell.

In the embodiment of a secondary zinc bromide battery, for example, positively charged zinc ions and negatively charged bromide ions need to be available at the anode and cathode electrode, respectively, during the charging process. The bromide anions at or near the cathode electrode (e.g., carbon material of the cathode assembly) that is exposed to the electrolyte are oxidized to bromine when the electrochemical cell or battery is charging. Conversely, during discharge, the bromine is reduced to bromide anions. The conversion between bromine and bromide anions at or near the cathode electrode can be expressed as follows:

Br₂2e⁻→2Br⁻.

However, in concentrated aqueous electrolytes which are required for higher energy batteries, zinc thermodynamically prefers to form higher order negatively charged complexes with halides, which in the example with bromides are, specifically, [ZnBr₃]⁻ and [ZnBr₄]²⁻. These negatively charged zinc species subsequently migrate to the cathode rather than anode during charging process, which results in the anode becoming zinc starved during high zinc halide utilization. This limits the electrolyte utilization and requires battery cells to contain more zinc halide than is theoretically required if only positively charged zinc ions and negatively charged halide ions existed in solution, subsequently increasing the cost of the battery.

The inventors of the present disclosure have found that one pathway to reducing the formation of higher order negatively charged complexes with halides, such as [ZnBr₃]⁻and [ZnBr₄]²⁻, is to add zinc to the electrolyte in the form of one or more zinc additives, which are zinc salts with anions that are not halides. Adding zinc salts without halide anions increases the molar ratio of zinc ion to halide ion in the electrolyte, which reduces the equilibrium formation of higher order negatively charged complexes with halides, such as [ZnBr₃]⁻ and [ZnBr₄]²⁻. However, the one or more zinc additives need to have a non-halide anion that is electrochemically inert. Further, both the zinc cation and the non-halide anion need to also be highly soluble in the resulting aqueous electrolyte, such that sufficient amount of the one or more zinc additives can be dissolved to impact the molar ratio of zinc ion to halide ion. The one or more zinc additives of the present disclosure not only meet these requirements and reduce the formation of higher order negatively charged zinc complexes (such as [ZnBr₃]⁻ and [ZnBr₄]²⁻), but also provide other benefits to a zinc halide battery, as described below.

One aspect of the present disclosure provides an electrolyte for use in a secondary zinc halide electrochemical cell comprising: from about 20 wt. % to about 70 wt. % of a zinc halide of formula ZnY₂ or any combination of zinc halides of formula ZnY₂, wherein Y is a halide selected from fluoride, chloride, bromide, iodide, or any combination thereof; from about 10 wt. % to about 79 wt. % of H₂O; and from about 0.5 wt. % to about 20 wt. % of one or more zinc additives. The one or more zinc additives comprises a first zinc additive. The first zinc additive is a salt that is not a zinc halide and comprises an anion with a van der Waals volume of greater than about 65 Å³.

In some embodiments, the electrolyte comprises from about 0.5 wt. % to about 3 wt. % of the one or more zinc additives. In some embodiments, a molar ratio of total zinc ion to halide ion in the electrolyte is from about 1:2 to about 1:3.

In some embodiments, the electrolyte comprises from about 0.5 wt. % to about 20 wt. % of the one or more zinc additives. In some embodiments, a molar ratio of total zinc ion to halide ion in the electrolyte is from about 1:1 to about 1:2.5.

In some embodiments, the one or more zinc additives further comprise a second zinc additive that is different from the first zinc additive. The second zinc additive is a salt that is not a zinc halide and comprises an anion with a van der Waals volume of smaller than about 65 Å³. In some embodiments, the electrolyte comprises from about 0.5 wt. % to about 15 wt. % of the second zinc additive.

Non-limiting examples of the first zinc additive of the present disclosure include, e.g., zinc trifluoromethanesulfonate, zinc perfluorobutanesulfonate, zinc bis(trifluoromethane)sulfonimide, zinc methanosulfonate, zinc p-toluenesulfonate, zinc hexafluorophosphate, zinc tetrakis[3,5-bis(trifluoromethyl)phenyl]borate, or any combination thereof.

Non-limiting examples of the second zinc additive of the present disclosure include, e.g., zinc nitrate, zinc sulfate, zinc perchlorate, zinc tetrafluoroborate, or any combination thereof.

Measurement of a van der Waals volume is well-known to those having ordinary skill in the art. For example, see Zhao, Y. H., et al., “Fast Calculation of van der Waals Volume as a Sum of Atomic and Bond Contributions and Its Application to Drug Compounds,”J. Org. Chem., 68, 7368-7373 (2003), which is incorporated herein by reference, may be used within the scope of the disclosure. The van der Waals volume of some of the examples of the first zinc additive of the present disclosure are provided in TABLE 1 below.

TABLE 1

| NON-HALIDE ANION | van der Waals Volume (Å³) |
|---|---|
| triflate (trifluoromethanesulfonate) | 87.6 |
| perfluorobutanesulfonate | 131.0 |
| bis(trifluoromethane)sulfonimide | 161.4 |
| methanesulfonate | 69.4 |
| p-toluenesulfonate | 142.0 |
| hexafluorophosphate | 68.7 |
| tetrakis[3,5-bis(trifluoromethyl)phe- | 609.4 |
| nyl]borate | |

The van der Waals volume of some of the examples of the second zinc additive of the present disclosure are provided in TABLE 2 below.

TABLE 2

| NON-HALIDE ANION | van der Waals Volume (Å³) |
|---|---|
| sulfate | 59.6 |
| tetrafluoroborate | 59.2 |
| perchlorate | 57.6 |
| nitrate | 42.0 |

As used herein, “zinc halide utilization” in the electrolyte refers to the moles of zinc electrochemically consumed divided by the moles of zinc available in the electrolyte of the cell. The addition of the one or more zinc additives of the present disclosure to the electrolyte has also been found to advantageously improve zinc halide utilization in the electrolyte of the secondary zinc halide electrochemical cell. In some embodiments, the zinc halide utilization in the electrolyte of the secondary zinc halide electrochemical cell is increased by about 5% to about 40% compared to an equivalent electrolyte in a secondary zinc halide electrochemical cell without the one or more zinc additives.

As used herein, “coulombic efficiency” of a secondary battery refers to the ratio of discharge capacity to charge capacity within the same cycle. The addition of the one or more zinc additives of the present disclosure to the electrolyte has also been found to advantageously improve the coulombic efficiency of the secondary zinc halide electrochemical battery. In some embodiments, the coulombic efficiency of the secondary zinc halide electrochemical battery is increased by about 5% to about 25% compared to a secondary zinc halide electrochemical battery without the one or more zinc additives. As seen in the EXAMPLES below, higher coulombic efficiency can be achieved at higher zinc halide utilization in electrolytes with the one or more zinc additives of the present disclosure.

The inventors of the present disclosure have also unexpectedly found that the addition of the one or more zinc additives of the present disclosure to the electrolyte provides improved zinc plating morphology and increases the viscosity of the electrolyte. Higher viscosity electrolytes allow for polyhalides (such as Br₃⁻ and Br₅⁻) to remain in the cathode and slow diffusion of the polyhalides species out of the cathode. Notably, higher viscosity is accomplished without linearly decreasing conductivity with zinc additives. Further, some of the one or more zinc additives are highly soluble in aqueous concentrated zinc halide electrolytes.

In some embodiments, the electrolyte further comprises other components suitable within the scope of the disclosure. For example, the additional components in the electrolytes described in PCT Publication No. WO 2016/057477, filed Oct. 6, 2015, in PCT Publication No. WO 2017/172878, filed Mar. 29, 2017, in U.S. Pat. No. 10,276,872, filed Mar. 29, 2016, and in U.S. Patent Application Publication No. 2011/0253553 A1, filed Mar. 21, 2011, all of which are incorporated herein by reference, may be used within the scope of the disclosure.

In some embodiments, the electrolyte further comprises from about 0.5 wt. % to about 15 wt. % of KBr and from about 0.5 wt. % to about 15 wt. % of KCl.

In some embodiments, the electrolyte further comprises from about 0.05 wt. % to about 20 wt. % of one or more quaternary ammonium agents. Each quaternary ammonium agent is independently selected from a quaternary ammonium agent having a formula N⁺(R¹)(R²)(R³)(R⁴)X⁻, wherein R¹ is hydrogen or an alkyl group, R², R³, and R⁴ are each independently an alkyl group that is same or different from R¹, and X⁻ is chloride or bromide. In some embodiments, the one or more quaternary ammonium agents comprises a first quaternary ammonium agent with a concentration from about 0.05 wt. % to about 20 wt. %.

In some embodiments, the first quaternary ammonium agent is selected from a tetra-C₁₋₆ alkyl ammonium chloride or a tetra-C₁₋₆ alkyl ammonium bromide. In some embodiments, the first quaternary ammonium agent is tetramethylammonium chloride, tetraethylammonium chloride, tetrapropylammonium chloride, tetrabutylammonium chloride, tetramethylammonium bromide, tetraethylammonium bromide, tetrapropylammonium bromide, or tetrabutylammonium bromide.

In some embodiments, the one or more quaternary ammonium agents further comprises a second quaternary ammonium agent. In some embodiments, the second quaternary ammonium agent has a formula N⁺(R¹)(R²)(R³)(R⁴)X⁻, wherein R¹ is hydrogen or an alkyl group, R², R³, and R⁴ are each independently an alkyl group that is same or different from R¹, and X⁻ is chloride or bromide. In some embodiments, the concentration of the second quaternary ammonium agent is from about 0.05 wt. % to about 20 wt. %.

In some embodiments, the second quaternary ammonium agent is a chloride or bromide of trimethylethylammonium, trimethyl propylammonium, trimethylbutylammonium, triethylmethylammonium, triethylpropylammonium, triethylbutylammonium, tripropylmethylammonium, tripropylethylammonium, or tripropylbutylammonium.

In some embodiments, the electrolyte further comprises from about 0.25 wt. % to about 5 wt. % of a glycol, wherein the glycol is ethylene glycol, propylene glycol, 1,3-butylene glycol, 1,4-butylene glycol, neopentyl glycol, hexalene glycol, or any combination thereof. In one embodiment, the glycol is neopentyl glycol.

In some embodiments, the electrolyte further comprises from about 0.5 wt. % to about 10 wt. % of a glyme, wherein the glyme is monoglyme, diglyme, triglyme, tetraglyme, pentaglyme, hexaglyme, or any combination thereof. In one embodiment, the glyme is tetraglyme.

In some embodiments, the electrolyte further comprises less than 1 wt. % of one or more additives selected from Sn, In, Ga, Al, Tl, Bi, Pb, Sb, Ag, Mn, Fe, or any combination thereof.

In some embodiments, the electrolyte further comprises from 0.1 wt. % to 2 wt. % of acetic acid, sodium acetate, potassium acetate, or any combination thereof.

In some embodiments, the electrolyte comprises: from about 25 wt. % to about 45 wt. % of a zinc halide of formula ZnY₂ or any combination of zinc halides of formula ZnY₂; from about 25 wt. % to about 50 wt. % of H₂O; from about 1 wt. % to about 20 wt. % of the one or more zinc additives; from about 0.5 wt. % to about 15 wt. % of KBr; from about 0.5 wt. % to about 15 wt. % of KCl; and from about 0.05 wt. % to about 20 wt. % of the one or more quaternary ammonium agents.

In some embodiments, the electrolyte is used in a static zinc halide electrochemical cell. In some embodiments, the electrolyte further comprises from about 0.2 wt. % to about 2.5 wt. % of DME-PEG. In some embodiments, the electrolyte comprises DME-PEG with a number average molecular weight of about 1000 amu, DME-PEG with a number average molecular weight of about 2000 amu, or a combination thereof.

In some embodiments, the electrolyte is used in a flow zinc halide electrochemical cell. In some embodiments, the electrolyte does not comprise DME-PEG.

### B. Bipolar Electrochemical Battery

Another aspect the present disclosure provides a secondary zinc halide battery comprising the electrolyte described above. The secondary zinc halide battery may be a static (non-flowing) secondary zinc halide battery or a flow secondary zinc halide battery.

### B.1. Static Bipolar Electrochemical Battery

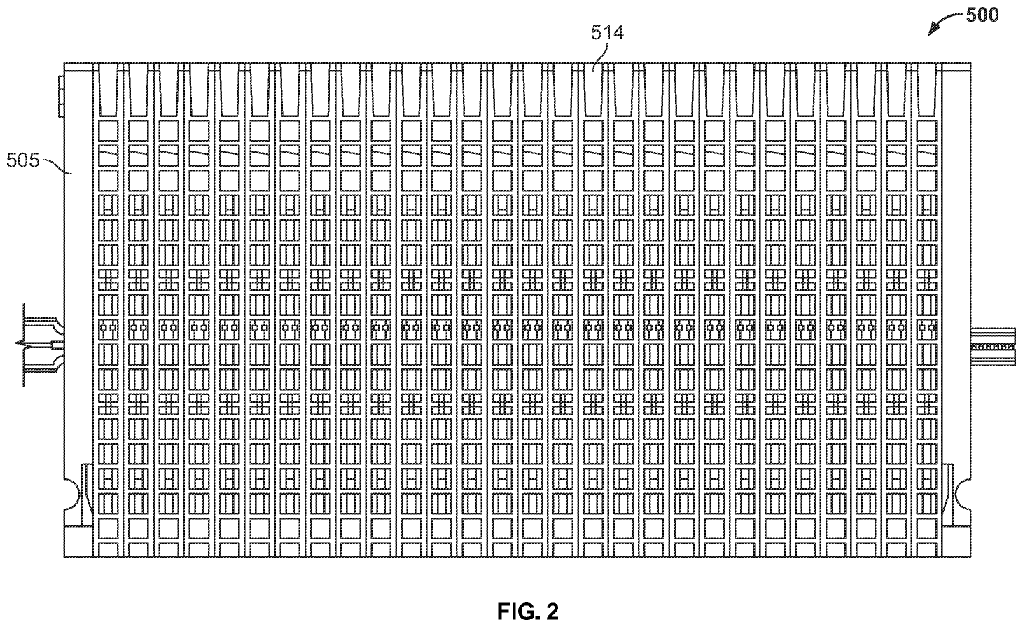

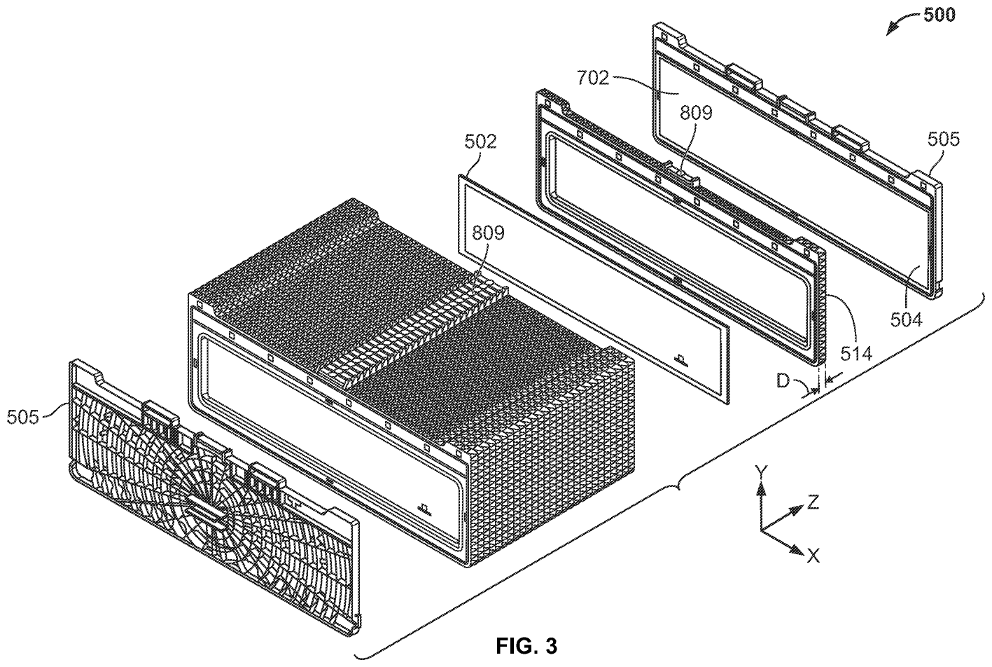

Referring to FIGS. 2 and 3, an embodiment of a static (non-flowing) bipolar zinc halide secondary electrochemical battery 500 of the present disclosure comprises at least one bipolar electrochemical cell and two terminal electrochemical cells. In some embodiments, the bipolar electrochemical battery comprises about 10 to 50 bipolar electrochemical cells in series and two terminal electrochemical cells. For example, in one embodiment, the bipolar electrochemical battery comprises 26 bipolar electrochemical cells in series and two terminal electrochemical cells. In another embodiment, the bipolar electrochemical battery comprises 38 bipolar electrochemical cells in series and two terminal electrochemical cells.

### B.1.i. Bipolar Electrochemical Cell

The at least one bipolar electrochemical cell comprises a bipolar electrode 502, a battery frame member 514, and a zinc halide electrolyte. The terminal electrochemical cell comprises a bipolar electrode 502, a battery frame member 514, a terminal assembly 504, a terminal endplate 505, and a zinc halide electrolyte.

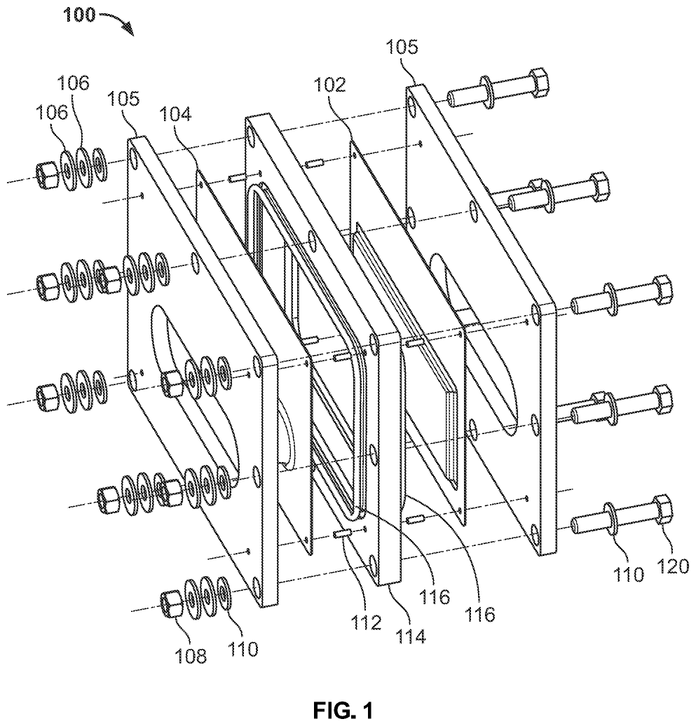

FIG. 1 shows an exploded view of an electrochemical cell 100 of the present disclosure, which comprises a bipolar electrode 102, a battery frame member 114, a terminal assembly 104, and the zinc halide electrolyte described above.

### 1. Bipolar Electrodes

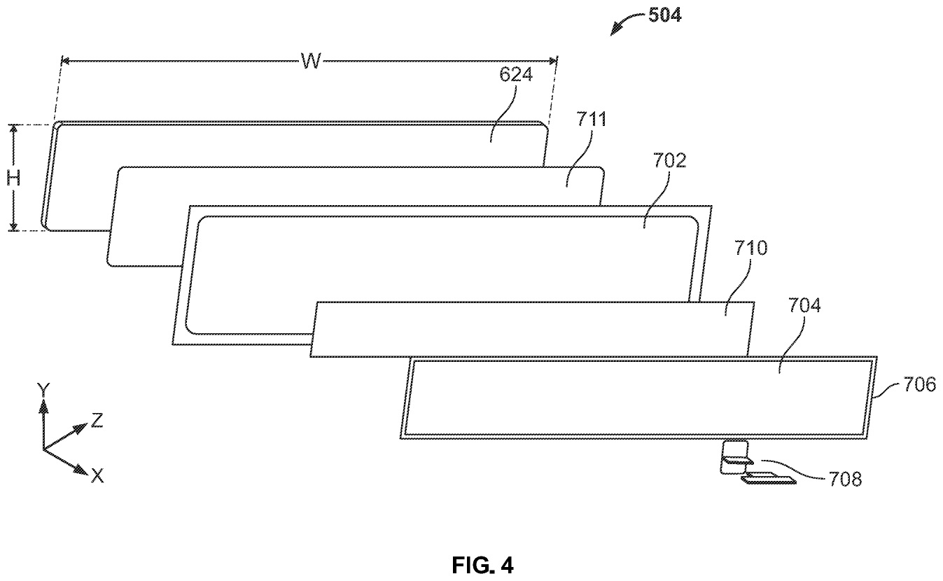

Referring to FIGS. 3 and 4, bipolar electrodes 502 of present disclosure comprise a bipolar electrode plate 702 having an anode surface on one side of the bipolar electrode plate and a cathode surface on another side of the bipolar electrode plate that is opposite the anode surface. On the cathode surface of the bipolar electrode plate 702, a carbon material 624 is affixed to the surface of the bipolar electrode plate 702 using an adhesive layer 711 so that the carbon material 624 electrically communicates with at least the surface of the bipolar electrode plate 702. The structure of the bipolar electrodes 502 is described by referring to the exploded view of the terminal assembly 504 in FIG. 4 as the structure of the bipolar electrodes 502 is identical to the structure of the bipolar electrode of the terminal assembly 504.

Bipolar electrodes 502 of the present disclosure are configured to plate zinc metal on an anodic electrode surface and generate halide or mixed halide species during charging of the electrochemical cell that are reversibly sequestered in the carbon material. Conversely, these electrodes are configured to oxidize plated zinc metal to generate Zn²⁻ cations and reduce the halide or mixed halide species to their corresponding anions during discharging of the electrochemical cell.

### a. Bipolar Electrode Plates

The bipolar electrode plate 702 comprises a conductive coating or a film that is relatively inert to the zinc halide electrolyte used in the electrochemical battery. In some embodiments, the coating or the film covers a portion of the surface of the bipolar electrode plate 702. In some embodiments, the bipolar electrode plate 702 comprises titanium, titanium oxide, TiC, TiN, or graphite. Optionally, the bipolar electrode plate 702 is a plastic material that is rendered conductive by incorporating a conductive filler into the plastic. In some embodiments, the bipolar electrode plate 702 comprises a titanium material (e.g., titanium or titanium oxide). In other embodiments, the bipolar electrode plate 702 comprises a titanium material that is coated with a titanium carbide material. In these embodiments, at least a portion of the surface of the bipolar electrode plate 702 is coated with the titanium carbide material. In some embodiments, the bipolar electrode plate 702 comprises an electrically conductive carbon material (e.g., a graphite plate). In some instances, the bipolar electrode plate 702 comprises a graphite plate that is coated with a titanium carbide material. In these embodiments, at least a portion of the surface of the bipolar electrode plate 702 is coated with the titanium carbide material. In some embodiments, the bipolar electrode plate 702 comprises an electrically conductive plastic. Any suitable electrically conductive plastic may be used within the scope of the invention. Conductive plastics are well known to one skilled in the art and not described in detail herein. Such electrically conductive plastic material may comprise a base resin polymer with carbon black, graphite, fumed silica, or combinations thereof. For example, electrically conductive plastics described in U.S. Pat. No. 4,169,816, filed Mar. 6, 1978, which is incorporated herein by reference, may be used within the scope of the disclosure.

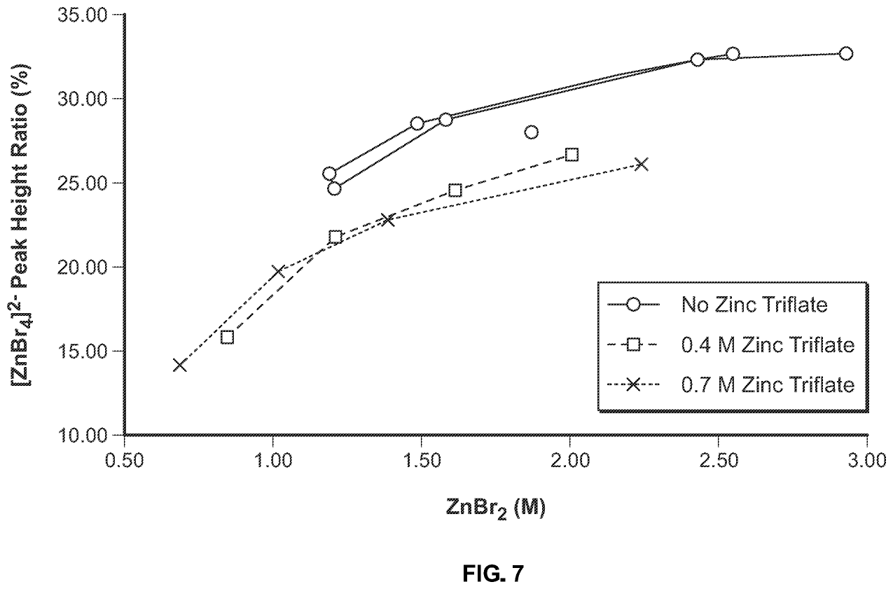

In some embodiments, the bipolar electrode plates may be substantially rectangular, with one dimension being visibly greater than the other so as to convey a rectangular appearance. In the X-Y-Z coordinate space illustrated in FIG. 3, the width dimension of the terminal assembly 504 is in the X direction and it is the greater dimension relative to Y. The height dimension of the terminal assembly 504 is in the Y direction and it is a shorter dimension compared with the X dimension, giving the illustrated terminal assembly 504 and the exploded battery a rectangular appearance. The Z direction is representative of the depth (i.e., thickness) of the illustrated battery components. As seen in FIGS. 3 and 4, the orientation of the bipolar electrode plates and the orientation of the carbon material are complementary to the orientation of the terminal assembly 504 such that the width and the height of the bipolar electrode plates and the width and height of the carbon material share about the same orientation as the width and the height, respectively, of the terminal assembly 504 shown in FIG. 7.

The bipolar electrode plates may be formed by stamping or other suitable processes. A portion of the surface of the bipolar electrode plate 702 may optionally undergo surface treatments (e.g., coating or the like) to enhance the electrochemical properties of the cell or battery. The inner surface of the bipolar electrode plate may include an electrochemically active region associated with or defined by the formation of a layer of zinc metal upon cell or battery charging. In some embodiments, the inner surface of the electrode plate may be sandblasted or otherwise treated within the electrochemically active region. In other embodiments, the outer surface may also be sandblasted within an electrochemically active region associated with a region enclosed by the cathode assembly.

For example, in some embodiments, at least a portion of the inner surface, at least a portion of the outer surface, or at least portions of both surfaces are treated (e.g., sandblasted) to give a rough surface. In some instances, at least a portion of the inner surface of the bipolar electrode plate is treated (e.g., sandblasted) to give a rough surface. In some instances, the region of the inner surface that is treated to give a rough surface is substantially defined by the periphery of the cathode assembly affixed to the outer surface of the electrode plate.

### b. Cathode Assemblies

The electrochemical cell of the present disclosure comprises a cathode assembly that is situated on the cathode surface of the bipolar electrode plate 702. In some embodiments, the cathode assembly comprises at least one carbon material 624 and an adhesive layer 711 electrically connecting the carbon material 624 to a bipolar electrode plate 702. The carbon material is situated on the coating material that is on the surface (e.g., the cathodic surface) of the bipolar electrode plate 702. In other embodiments, the cathode assembly comprises a cathode cage, which electrically connects the carbon material 624 to the cathode surface of the bipolar electrode plate 702. A cathode cage is described in U.S. Provisional Application No. 63/168,699, filed Mar 31, 2021, which is incorporated herein by reference, may be used within the scope of the disclosure.

### i. Carbon Material

The carbon material 624 is in electrical communication with the surface of the bipolar electrode plate 702 and is adhered to the bipolar electrode plate 702 using an adhesive layer 711. Carbon materials suitable for electrochemical cells of the present disclosure may comprise any carbon material that can reversibly absorb aqueous bromine species (e.g., aqueous bromine or aqueous bromide) and is substantially chemically inert in the presence of the electrolyte. In some embodiments, the carbon material comprises carbon blacks or other furnace process carbons. Suitable carbon black materials include, but are not limited to, Cabot Vulcan® XC72R, Akzo-Nobel Ketjenblack EC600JD, and other matte black mixtures of conductive furnace process carbon blacks. In some embodiments, the carbon material may also include other components, including but not limited to a PTFE binder and de-ionized water. For example, the carbon material has a water content of less than 50 wt. % (e.g., from about 0.01 wt. % to about 30 wt. %) by weight of the carbon material. In some embodiments, the carbon material comprises PTFE (e.g., from about 0.5 wt. % to about 5 wt. % by weight of the carbon material).

In some embodiments, the carbon material may be in the form of one or more thin rectangular blocks. In some embodiments, the carbon material may comprise a single solid block. In other embodiments, the carbon material may comprise from one to five, one to three, or one to two solid blocks of carbon blacks.

In some embodiments, the carbon material may be comprised of a woven carbon fiber or a non-woven carbon felt material.

In some embodiments, the carbon material may be substantially rectangular, with one dimension being visibly greater than the other so as to convey a rectangular appearance. In the X-Y-Z coordinate space illustrated in FIGS. 3 and 4, the width dimension of the carbon material 624 is in the X direction (illustrated in FIG. 4 as “W”) and it is the greater dimension relative to Y, which gives the article a rectangular appearance. The height dimension of the carbon material 624 is in the Y direction (illustrated in FIGS. 4 and 10 as “H”) and it is the shorter dimension relative to the width dimension. The orientation of the bipolar electrochemical battery 500 and the orientation of the carbon material 624 are complementary such that the width and the height of bipolar electrochemical battery 500 are share about the same orientation as the width and the height, respectively, of the carbon material 624. A battery with such an embodiment of the carbon material is described in U.S. application Ser. No. 17/410,552, filed Aug. 24, 2021, which is incorporated herein by reference, may be used within the scope of the disclosure.

### 2. Terminal Assembly

Referring to FIG. 4, a terminal assembly 504 of the present disclosure comprises a terminal connector 708; a conductive flat-plate 704 with an electrically conducting perimeter 706; an electrically insulating tape member 710; and a terminal bipolar electrode plate 702. The conductive flat-plate 704, the terminal bipolar electrode plate 702 and the electrically insulating tape member 710 each have inner and outer surfaces at least substantially parallel with each other, wherein the outer surface of the conductive flat-plate 704 is joined to the terminal connector 708, the inner surface of the conductive flat-plate 704 is joined to the outer surface of the terminal bipolar electrode plate 702, with the electrically insulating tape member 710 disposed in between the inner surface of the conductive flat-plate 704 and the outer surface of the bipolar electrode plate 702 such that the electrically insulating tape member 710 does not cover the entire inner surface area of the conductive flat-plate 704, and wherein the electrically conducting perimeter 706 enables bi-directional uniform current flow through the conductive flat-plate 704 between the terminal connector 708 and the terminal bipolar electrode plate 702.

Since the insulating tape member 710 does not cover entire surface of the conductive flat-plate 704, it permits the electrically conducting perimeter 706 to be in electrical communication with the terminal bipolar electrode plate 702. In some embodiments, the dimensions of the insulating tape member 710 is smaller than the dimensions of the conductive flat-plate 704. The terminal connector 708 of the bipolar electrochemical battery is connected for electrical communication with the conductive flat-plate 304. In some embodiments, the outer surface of the conductive flat-plate 704 is joined to the terminal connector 708. In some embodiments, the terminal connector 708 comprises any electrically conducting material. In one embodiment, the terminal connection comprises brass (e.g., the terminal connector is a tab assembly that electrically communicates or contacts the terminal perimeter).

The terminal bipolar electrode plate 702 of the terminal assembly 504 has inner and outer surfaces at least substantially parallel with the inner and outer surfaces of the conductive flat-plate 704 and electrically insulating tape member 710. The terminal bipolar electrode plate 702 may comprise, without limitation, a titanium material that is coated with a titanium carbide material, thru holes, rough inner surface, or the like. The electrically conducting perimeter 706 of the flat-plate 704 with electrically insulating tape member 710 joins to the terminal bipolar electrode plate 702 such that the electrically conducting perimeter 706 is approximately centered about the electrochemically active region of the terminal bipolar electrode plate 702. In some embodiments, the electrochemically active region corresponds to a region extending between the inner and outer surfaces of the terminal bipolar electrode plate 702 in chemical or electrical communication with the adjacent bipolar electrode plate during charge and discharge cycles of the electrochemical battery. In these embodiments, the electrochemically active region for the terminal bipolar electrode plate 702 associated with the cathode terminal of the battery corresponds to or is defined by an area enclosed by a cathode assembly disposed upon the inner surface of the terminal bipolar electrode plate 702 (e.g., the terminal cathode electrode plate). The electrochemically active region for the terminal bipolar electrode plate 702 associated with the anode terminal of the battery may correspond to an area on its inner surface that opposes a cathode assembly disposed on the front surface of an adjacent bipolar electrode plate and forms a layer of zinc metal upon charging of the battery (terminal anode assembly). In some embodiments, at least a portion of the surface (e.g., at least the chemically active region) of the terminal bipolar electrode plate 702 of the terminal anode assembly is a rough surface.

FIG. 4 provides an exploded view of a terminal assembly for use in the battery of FIG. 2 showing the cathode carbon material 624, the adhesive layer 711, the terminal bipolar electrode plate 702, the electrically insulating tape member 710, the conductive flat-plate 704, the electrically conducting perimeter 306, and the terminal connector 708.

In some embodiments, the electrically conducting perimeter 706 formed by welding is centered within the electrochemically active region of the terminal bipolar electrode plate 702. In some embodiments, the electrically conducting perimeter 706 is substantially rectangular, substantially circular or substantially elliptical. In some embodiments, the electrically conducting perimeter 706 is substantially rectangular.

In some embodiments, the conductive flat-plate 704 with electrically insulating tape member 710 is centered within the electrochemically active region of the terminal bipolar electrode plate 702.

In some embodiments, the surface of the electrically insulating tape member is joined to the surface of the conductive flat-plate by a weld or an adhesive. In some embodiments, the adhesive is electrically conductive.

The conductive flat-plate described herein is larger than prior art current aggregators, and hence, it provides more contact points and better current density distribution. This reduces manufacturing costs.

In some embodiments, the terminal assembly is a terminal cathode assembly, wherein the terminal cathode assembly comprises a terminal bipolar electrode plate 702 having an electrochemically active region, a conductive flat-plate 704 with electrically insulating tape member 710 disposed on the surface of the terminal bipolar electrode plate 702 and approximately centered in the electrochemically active region, and a cathode assembly such as any of the cathode assemblies described herein disposed on the inner surface of the terminal bipolar electrode plate 702.

In some embodiments, the terminal assembly is a terminal anode assembly, wherein the terminal anode assembly comprises a terminal bipolar electrode plate 702 having an electrochemically active region, a conductive flat-plate 704 with electrically insulating tape member 710 centered in the electrochemically active region, and wherein the terminal anode assembly lacks a cathode assembly.

In some embodiments, the electrically conducting perimeter 706 of the conductive flat-plate 704 with electrically insulating tape member 710 is joined to the surface of the terminal bipolar electrode plate 702 by a weld or an adhesive. In some instances, the adhesive is electrically conductive. Non-limiting examples of suitable electrically conductive adhesives include graphite filled adhesives (e.g., graphite filled epoxy, graphite filled silicone, graphite filled elastomer, or any combination thereof), nickel filled adhesives (e.g., nickel filled epoxy), silver filled adhesives (e.g., silver filled epoxy), copper filled adhesives (e.g., copper filled epoxy), any combination thereof, or the like.

In some embodiments, the conductive flat-plate 704 with electrically insulating tape member 710 is composed of at least one of a copper alloy, a copper/titanium clad, aluminum, titanium, and electrically conductive ceramics.

In some embodiments, at least one of the conductive flat-plate 704 with electrically insulating tape member 710 or the terminal bipolar electrode plate 702 comprises titanium. In some embodiments, at least one of the conductive flat-plate 704 with electrically insulating tape member 710 or the terminal bipolar electrode plate 702 comprises a titanium material coated with a titanium carbide material.

In some embodiments, the inner surfaces of at least one of the conductive flat-plate 704 with electrically insulating tape member 710 comprises copper.

In some embodiments, the outer surface of at least one of the conductive flat-plate 704 with electrically insulating tape member 710 comprises at least one of copper, titanium, and electrically conductive ceramics.

In some embodiments, the conductive flat-plate 704 with electrically insulating tape member 710 comprises a first metal and the terminal bipolar electrode plate 702 comprises a second metal.

In some embodiments, the electrically insulating tape member 710 may be comprised of any adhesive material that is electrically insulating in nature. Non-limiting examples of the electrically insulating tape member 710 include, for example, Kapton™, Mylar™, polyimide, polyethylene, nylon, Teflon, neoprene, or any other electrically insulating polymer.

### 3. Battery Frame Members

In some embodiments, the battery of the present disclosure comprises a battery frame member 514 that is interposed between two adjacent bipolar electrodes or interposed between a bipolar electrode 502 and a terminal assembly 504 (e.g., a terminal anode assembly or a terminal cathode assembly).

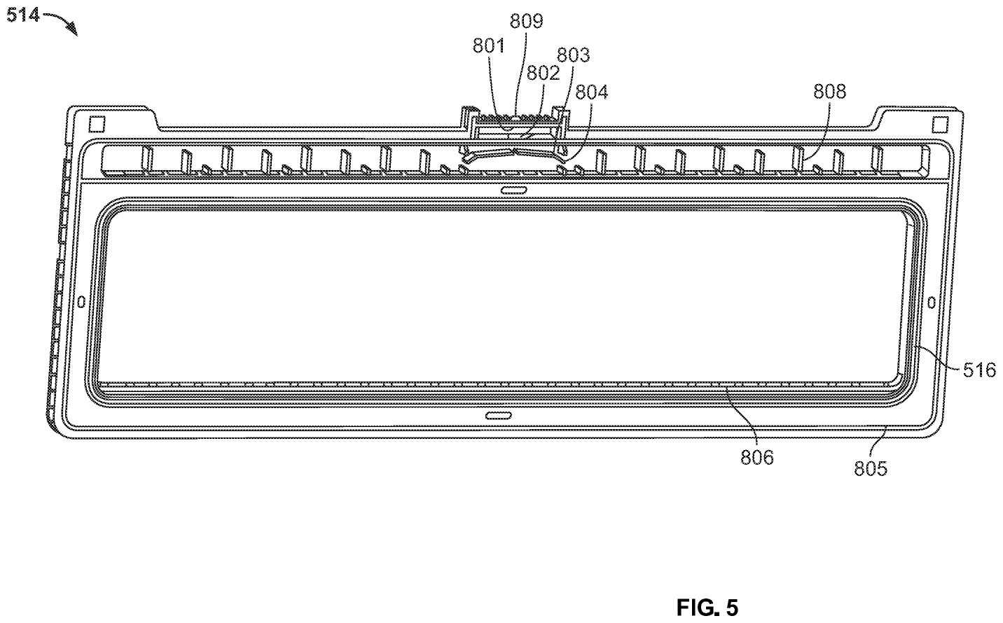

The width and the height of the battery frame member 514 are positioned complementary to the width “W” and the height “H”, respectively, of the carbon material 624. The width of the battery frame member 514 is the dimension along (parallel to) the bottom of the battery frame member 514, with the gas channel 801 located at the top of the battery frame member 514 (as illustrated in FIG. 5). In the X-Y-Z coordinate space illustrated in FIG. 3, the width dimension of the battery frame member 514 is in the X direction, while the height dimension of the battery frame member 514 is in the Y direction. The depth of the battery frame member 514 is in the Z direction and is the value of the dimension that is perpendicular to the height and the width of the battery frame member 514 (illustrated in FIG. 3 as “D”). In some embodiments, the frame member 514 is substantially rectangular, with one dimension being visibly greater than the other so as to convey a rectangular appearance.

In one embodiment, illustrated in FIG. 5, the battery frame member 514 has an outer periphery edge, and an inner periphery edge defining an open interior region. In some embodiments, the battery frame member 514 is configured such that open interior region is approximately centered about the center of an electrochemically active region of a terminal bipolar electrode plate 702 received by the battery frame member 514 and/or the center of a cathode assembly disposed on a terminal bipolar electrode plate 702. In some embodiments, the outer periphery of the battery frame member 514 defines the outer surface of a battery.

In some embodiments, the battery frame member 514 includes a first side that opposes and retains the first (terminal) bipolar electrode plate 702 and a second side disposed on an opposite side of the battery frame member 514 than the first side that opposes and retains a second bipolar electrode plate. The second electrode plate is adjacent and parallel to the first electrode plate in the battery. The first and second electrode plates and the terminal electrode plate(s) may be configured to have substantially the same size and shape. In some embodiments, the battery frame member 514 is in contact with an anode bipolar electrode plate on one side and a cathode bipolar electrode plate of the adjacent bipolar cell on the other side.

In some embodiments, the battery frame member 514 includes a sealing member 516 (FIG. 5) that extends around the inner periphery edge of the entire frame. In some embodiments, the battery frame member 514 comprises a first sealing member 516 disposed along the first inner periphery edge. In some embodiments, the first sealing member is an O-ring. In some embodiments, the first sealing member 516 is a gasket. In some embodiments, each inner periphery edge is configured to receive a sealing member 516 seated therein that forms a substantially leak-free seal when the seal is compressed between the corresponding bipolar electrode plate or terminal electrode plate and the battery frame member 514 when the electrochemical battery is assembled to provide a sealing interface between the bipolar electrode plate or endplate and the battery frame member 514. The sealing members cooperate to retain the electrolyte between the opposing bipolar electrode plates and a battery frame member 514, or between a bipolar electrode plate, a terminal electrode plate and a frame member 514. In some embodiments the sealing member 516 is overmolded onto the frame member 514. In some embodiments, the sealing member 516 is applied to the frame member 514 using a form in place liquid curing process. In some embodiments, the sealing member 516 extends above the depth of the frame member 514 and is compressed during assembly.

In some embodiments, the battery frame member 514 comprises a gutter in the bottom portion of the battery frame member 514 to prevent voltage anomalies during cycling. In some embodiments, the gutter comprises a gutter shelf 406 and a void space 407 underneath the gutter shelf 406. In some embodiments, the cathode carbon material 624 rests on the gutter shelf 406. It has been found that the presence of the gutter shelf and the void underneath the gutter shelf prevent voltage anomalies during cycling. In some embodiments, there is no void space 407 underneath the gutter shelf 406 and the gutter shelf 406 extends to the bottom of the battery frame member 514. In some embodiments, the gutter shelf 406, upon which the cathode carbon material 624 rests, may be between 0.5 and 5 cm tall, including void space 407 under gutter shelf 406, and may be between 3 and 10 mm wide along the entire bottom portion of the battery frame member 514 width.

In some embodiments, the battery frame member comprises a first frame member and a second frame member. In some embodiments, the first frame member and the second frame member are horizontally stacked and vertically oriented, wherein a first outer edge of the first frame member is substantially coplanar with a second outer edge of the second frame member.

In some embodiments of a battery, each battery frame member 514 is plastic welded to the adjacent frame member 514 using a weld bead 805 around the perimeter of the battery frame member 514.

In some embodiments, the battery frame member 514 comprises a gas channel 801 on the top of the battery frame member 514 directly above a ventilation hole 802. The ventilation hole 802 allows gas to escape into the gas channel 801. In some embodiments, the gas channel 801 associated with each battery frame member 514 is covered, so there is no need to place a cover over the gas channel 801 after the battery frame members are assembled together. As described herein, the gas channel 801 is the battery headspace for the gases from the electrochemical cell in the battery frame member 514. In some embodiments, the frame members 514 are filled with electrolyte through a fill hole (plug 809 is inserted therein as illustrated) in the gas channel and the gas channel 801 also communicates with the ventilation hole 802. Once the battery is filled with electrolyte, a plug 809 is inserted into the fill hole to seal the gas channel 801 from the environment. In those embodiments where the fill hole and the ventilation hole 802 are not the same, the ventilation hole remains open to the gas channel during battery operation. In other embodiments, the electrolyte is added to the battery through the ventilation hole.

In some embodiments, a liquid diversion system exists in the top of the battery frame member 514 directly below the ventilation hole 802 which allows gas to escape into a gas channel 801. While the gas channel 801 provides gas communication throughout the battery 500, the liquid diversion system prevents liquid from entering the gas channel 801 via a series of features. In some embodiments, the liquid diversion system comprises a primary diverter 803 with two partial blocking walls 804 and multiple secondary blocking walls 808 ensuring liquid always is directed back to the open interior region within the battery frame member 514. In some embodiments, the primary diverter 803 consists of a horizontal plastic protrusion with end pieces facing downward with an angle ranging from 30 to 60 degrees. In some embodiments, secondary blocking walls ensure minimum fluid will reach the primary diverter. In some embodiments, the secondary blocking walls 808 herein are designed to alternate top down and bottom up relative to the frame member 514 in order to break any internal electrolyte waves caused by severe sloshing or tilting. One of the advantages of the liquid diversion system is that it improves quality of the battery by keeping electrolyte contained within frame member during transportation.

Each battery frame member 514 may be formed from flame retardant polypropylene fibers, high density polyethylene, polyphenylene oxide, or polyphenylene ether. Each battery frame member 514 may receive two adjacent bipolar electrode plates or a bipolar electrode plate and a terminal electrode plate. Each battery frame member 514 may also house an aqueous electrolyte solution (e.g., zinc halide electrolyte or zinc-bromide electrolyte), which is received via the ventilation hole 802.

### 4. Compression Plates

In some embodiments, the electrochemical cell or battery comprises a pair of compression plates located at the ends of the electrochemical cell or battery. Suitable compression plates may be, for example, the compression plates described in PCT Publication No. WO 2019/108513, filed Nov. 27, 2018, which is incorporated herein by reference, may be used within the scope of the disclosure.

### B.2. Flow Bipolar Electrochemical Battery

A flow secondary zinc halide battery used in the present disclosure is well-known to those having ordinary skill in the art. For example, such a flow battery and an electrolyte that may be used in such a battery are described in U.S. Patent Application Publication No. 2011/0253553 A1, which is incorporated herein by reference, may be used within the scope of the disclosure.

An embodiment of a flow bipolar zinc halide secondary battery contains two inert electrodes, with a separator centered between the electrodes at a suitable equidistance from each electrode. In some embodiments, the placement of the separator may be biased towards one electrode. The electrolyte is an aqueous solution of zinc halide with additional salt additives. The electrolyte is generally fed from two separate external reservoirs into the two separate compartments of the cell via a circulation system.

The electrolyte contains water soluble complexing agents that react quickly with molecular halogen on the cathodic side of the battery during charge, forming a dense, water-immiscible oil, which settles at the bottom of the catholyte reservoir. Mechanical means prevent recirculation of the halogen-containing oil, allowing for external containment of all elemental bromine generated during charge.

During discharge, the bromine-containing liquid that has settled at the bottom of the catholyte reservoir is reintroduced into the cathode side of the cell, allowing for the reduction of elemental halogen to form halide ions.

During charge and discharge, the electrolyte utilized on the anodic side is circulated, and zinc ions are plated onto the electrode as zinc metal during charge, and redissolved into solution as zinc ions during discharge.

### C. Bipolar Electrochemical Battery with a Zinc Metal Reservoir

In yet another aspect, the present disclosure provides a secondary zinc halide battery comprising a zinc metal reservoir. The reservoir is a source of zinc metal and is made up of zinc metal that is present in forms well-known to those having ordinary skill in the art. Non-limiting examples of the forms of the zinc metal in the zinc metal reservoir include, for example, a powder, a granule, a foil, a sheet, a wire, or shavings. This zinc metal and the zinc metal reservoir are present in the secondary zinc halide battery in addition to and are separate from the zinc plating of the anode that occurs during battery charging. In some embodiments, the zinc metal reservoir is in contact with the electrolyte and is used to replenish zinc in the electrolyte as described below.

The secondary zinc halide battery of this aspect of the present disclosure may be a static (non-flowing) secondary zinc halide battery or a flow secondary zinc halide battery, which may be substantially similar to the static (non-flowing) secondary zinc halide battery or a flow secondary zinc halide battery described above. Accordingly, the structure and functions of these secondary zinc halide batteries will not be described again in detail. However, the secondary zinc halide battery of this aspect of the present disclosure differs from the secondary zinc halide battery described above by having a zinc metal reservoir in the secondary zinc halide battery. In addition to having zinc metal reservoir in the secondary zinc halide battery, the other major difference from the secondary zinc halide batteries described above is that the zinc halide electrolyte in the secondary zinc halide battery is either the zinc halide electrolyte with the one or more zinc additives described above or a zinc halide electrolyte without the one or more zinc additives described above.

For example, in addition to the zinc metal reservoir, the secondary zinc halide battery of this aspect of the present disclosure also comprises: at least one electrochemical cell comprising at least one bipolar electrode and a zinc halide electrolyte. The bipolar electrode comprises a bipolar electrode plate having an anode surface on one side of the bipolar electrode plate and a cathode surface on another side of the bipolar electrode plate that is opposite the anode surface. The zinc halide electrolyte is in contact with the bipolar electrode plate. The zinc halide electrolyte is either the zinc halide electrolyte with the one or more zinc additives described above or a zinc halide electrolyte without the one or more zinc additives described above.

In some embodiments, the zinc metal reservoir is in the at least one electrochemical cell and is in contact with the electrolyte. For example, the zinc metal reservoir may be in the electrolyte. In some embodiments, the zinc metal reservoir is also in contact with the anode of the at least one electrochemical cell. However, the zinc metal reservoir is not in contact with the cathode of the at least one electrochemical cell.

The zinc metal in the zinc metal reservoir is such that the zinc metal can be accessed if the at least one electrochemical cell becomes unbalanced. Electrochemical cells may become unbalanced due to disparity in the efficiency of the anodic and cathodic reactions, which could lead to variability in the ratio of zinc ion to halide ion in the electrolyte. If the ratio of zinc ion to halide ion in the electrolyte is reduced due to low efficiency of the cathode compared to the anode, part of the zinc metal reservoir can dissolve into the electrolyte to restore the ratio of zinc ion to halide ion.

The zinc metal reservoir may be present in the at least one electrochemical cell in an amount from about 1 wt. % to about 20 wt. % of the electrolyte.

Without being bound by theory, it is hypothesized that the zinc metal in the zinc metal reservoir that is present in the at least one electrochemical cell would dissolve into the zinc halide electrolyte during battery operation, which would increase the ratio of zinc ion to halide ion in the electrolyte while the battery is charging by replacing the zinc ions in the electrolyte that are consumed during charging. Thus, by improving the ratio of zinc ion to halide ion (e.g., bromide ion) in the electrolyte, the addition of zinc metal reservoir in turn, reduces the formation of higher order negatively charged zinc complexes (e.g., [ZnBr₃]⁻ and [ZnBr₄]²⁻), which improves the coulombic efficiency.

### III. EXAMPLES

### Example 1: Preparation of Electrolytes Containing Non-Halide Zinc Additives

Aqueous electrolyte solutions were prepared containing zinc bromide in the concentration range of 0.7 M-2.9 M, zinc triflate in the concentration range 0.4 M-0.7 M, potassium halide salts in the concentration range 0.4-2.6 M and tetraalkylammonium salts in the concentration range 0.3-0.5 M. An aqueous electrolyte solution having a composition that is the same as the above, but with no zinc additive (such as zinc triflate) was also prepared and served as the control electrolyte solution.

### Example 2: Testing Electrolytes Containing Non-Halide Zinc Additives in Prototype Cells

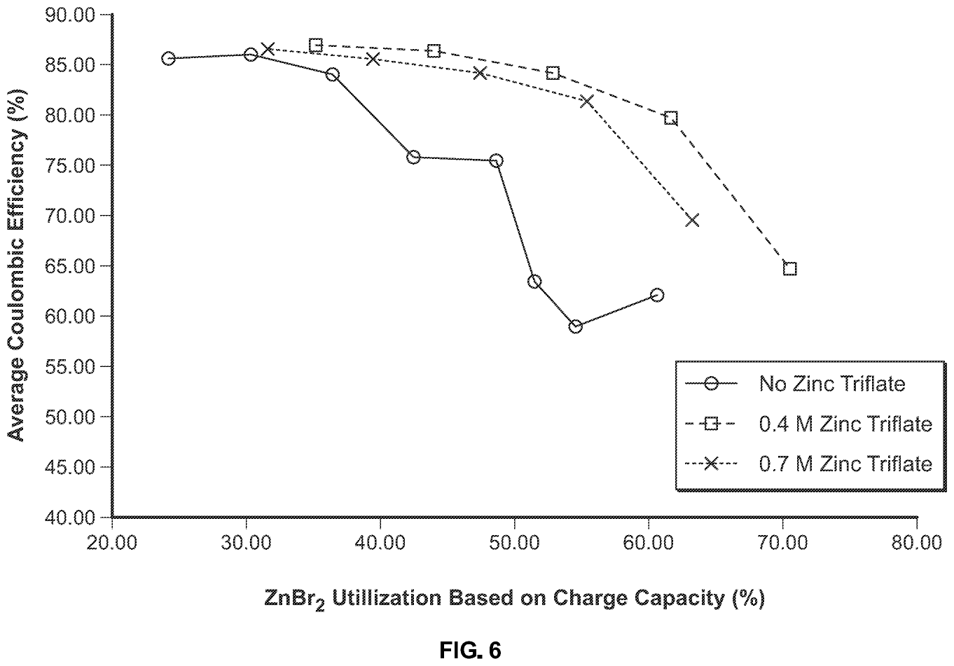

Test cells were assembled using titanium carbide coated titanium metal current collectors that were formed into plates. Anode and cathode plates were placed in a parallel configuration separated by a 12 mm thick high-density polyethylene frame containing an embedded sealing ring that allowed the cell to be sealed by compressing the components between two opposing steel compression plates. Prior to cell assembly, carbon felts were attached to cathode titanium current collectors using 13 ml of an electrically conductive, acetone-based glue. Assembled cells were filled with 210 ml of the electrolyte described in EXAMPLE 1. The test cells were cycled using an Arbin Instruments battery cycler. The cells were charged at a constant power of 4 W to a capacity of 8-16 Ah. The charge voltage limit was 2.4 V. The cells were discharged at a constant power of 4 W until the voltage reached 1.1 V. FIG. 6 shows the average coulombic efficiency of cell populations as a function of zinc bromide utilization of the electrolyte. Compared to the control electrolyte with no zinc triflate, the addition of 0.4-0.7 M zinc triflate lead to increased coulombic efficiency when charging to higher levels of zinc bromide utilization. Without being bound by theory, it is hypothesized that the zinc triflate improves the coulombic efficiency by improving the zinc to bromide ratio in the electrolyte and in turn, reducing the formation of higher order negatively charged zinc complexes such as [ZnBr₃]⁻ and [ZnBr₄]²⁻.

### EXAMPLE 3: Analysis of Zinc Halide Speciation Using Raman Spectroscopy

Samples of electrolyte were prepared as in EXAMPLE 1. Data was collected on a Renishaw in Via confocal Raman microscope using a 532 nm ex-citation laser. Samples were prepared by pipetting a droplet of electrolyte onto a silicon wafer and aligning the center of the droplet in the beam. Data points were collected at 2 cm⁻¹ intervals between 60 cm⁻¹-350 cm⁻¹. Laser intensity was adjusted to obtain optimal peak intensity between 120 cm⁻¹-210 cm⁻¹. Peak fitting of the Raman shifts was limited to the region between 127 cm⁻¹-203 cm⁻¹ containing the sharp peaks corresponding to [ZnBr₄]²⁻ (150 cm⁻¹), [ZnBr₃]⁻ (164 cm⁻¹) and ZnBr₂ (181cm⁻¹). To fit the peaks, a linear background was first applied joining the points at 127 cm⁻¹ and 203 cm⁻¹. Three Lorentzian peaks were fitted, their position limited to +/−1 cm⁻¹ of the expected values and the full width at half maximum limited to 14 cm⁻¹ (found empirically to give a good fit). FIG. 7 shows the [ZnBr₄]²⁻ peak height ratio for electrolytes with varying zinc bromide concentration. Compared to the control electrolyte with no zinc additive, the electrolytes containing 0.4-0.7 M zinc triflate had reduced [ZnBr₄]²⁻ peak height ratio at equivalent zinc bromide concentration.

### OTHER EMBODIMENTS

It should be apparent that the foregoing relates only to the preferred embodiments of the electrolyte and the battery disclosed herein, and that numerous changes and modifications may be made herein without departing from the spirit and scope of any invention as defined by the following claims and equivalents thereof.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. An electrolyte for use in a secondary zinc halide electrochemical cell comprising:
from about 20 wt. % to about 70 wt. % of a zinc halide of formula ZnY₂ or any combination of zinc halides of formula ZnY₂, wherein Y is a halide selected from fluoride, chloride, bromide, iodide, or any combination thereof;
from about 10 wt. % to about 79 wt. % of H₂O; and
from about 0.5 wt. % to about 20 wt. % of one or more zinc additives, wherein the one or more zinc additives comprises a first zinc additive, wherein the first zinc additive is a salt that is not a zinc halide and comprises an anion with a van der Waals volume of greater than about 65 Å³.

2. The electrolyte of claim 1, further comprising:
from about 0.5 wt. % to about 15 wt. % of KBr; and
from about 0.5 wt % to about 15 wt. % of KCl.

3. The electrolyte of claim 2, further comprising:
from about 0.05 wt. % to about 20 wt. % of one or more quaternary ammonium agents, wherein each quaternary ammonium agent is independently selected from a quaternary ammonium agent having a formula N⁺(R¹)(R²)(R³)(R⁴)X⁻, wherein R¹ is hydrogen or an alkyl group, R², R³, and R⁴ are each independently an alkyl group that is same or different from R¹, and X⁻ is chloride or bromide.

4. The electrolyte of claim 1, comprising from about 0.5 wt. % to about 3 wt. % of the first zinc additive.

5. The electrolyte of claim 4, wherein a molar ratio of total zinc ion to halide ion in the electrolyte is from about 1:2 to about 1:3.

6. The electrolyte of claim 1, comprising from about 0.5 wt. % to about 20 wt. % of the first zinc additive.

7. The electrolyte of claim 6, wherein a molar ratio of total zinc ion to halide ion in the electrolyte is from about 1:1 to about 1:2.5.

8. The electrolyte of claim 6, wherein the one or more zinc additives further comprises a second zinc additive, wherein the second zinc additive is a salt that is not a zinc halide and comprises an anion with a van der Waals volume of smaller than about 65 Å³.

9. The electrolyte of claim 8, comprising from about 0.5 wt. % to about 15 wt. % of the second zinc additive.

10. The electrolyte of claim 1, wherein the first zinc additive is zinc trifluoromethanesulfonate, zinc perfluorobutanesulfonate, zinc bis(trifluoromethane)sulfonimide, zinc methanosulfonate, zinc p-toluenesulfonate, zinc hexafluorophosphate, zinc tetrakis[3,5-bis(trifluoromethyl)phenyl]borate, or any combination thereof.

11. The electrolyte of claim 3, comprising:
from about 25 wt. % to about 45 wt. % of the zinc halide of formula ZnY₂ or any combination of zinc halides of formula ZnY₂;
from about 25 wt. % to about 50 wt. % of H₂O;
from about 1 wt. % to about 20 wt. % of the one or more zinc additives;
from about 0.5 wt. % to about 15 wt. % of KBr;
from about 0.5 wt. % to about 15 wt. % of KCl; and
from about 0.05 wt. % to about 20 wt. % of the one or more quaternary ammonium agents.

12. The electrolyte of claim 3, wherein the one or more quaternary ammonium agents comprises a first quaternary ammonium agent with a concentration from about 0.05 wt. % to about 20 wt. %, wherein the first quaternary ammonium agent is selected from a tetra-C₁₋₆ alkyl ammonium chloride or a tetra-C₁₋₆ alkyl ammonium bromide.

13. The electrolyte of claim 12, wherein the first quaternary ammonium agent is tetramethylammonium chloride, tetraethylammonium chloride, tetrapropylammonium chloride, tetrabutylammonium chloride, tetramethylammonium bromide, tetraethylammonium bromide, tetrapropylammonium bromide, or tetrabutylammonium bromide.

14. The electrolyte of claim 13, wherein the one or more quaternary ammonium agents further comprises a second quaternary ammonium agent, wherein the second quaternary ammonium agent has a formula N⁺(R¹)(R²)(R³)(R⁴)X⁻, wherein R¹ is hydrogen or an alkyl group, R², R³, and R⁴ are each independently an alkyl group that is same or different from R¹, and X⁻ is chloride or bromide, and wherein a concentration of the second quaternary ammonium agent is from about 0.05 wt. % to about 20 wt. %.

15. The electrolyte of claim 14, wherein the second quaternary ammonium agent is a chloride or bromide of trimethylethylammonium, trimethyl propylammonium, trimethylbutylammonium, triethylmethylammonium, triethylpropylammonium, triethylbutylammonium, tripropylmethylammonium, tripropylethylammonium, or tripropylbutylammonium.

16. The electrolyte of claim 3, further comprising from about 0.2 wt. % to about 2.5 wt. % of DME-PEG.

17. The electrolyte of claim 16, wherein the electrolyte comprises DME-PEG with a number average molecular weight of about 1000 amu, DME-PEG with a number average molecular weight of about 2000 amu, or a combination thereof.

18. The electrolyte of claim 3, further comprising from about 0.25 wt. % to about 5 wt. % of a glycol, wherein the glycol is ethylene glycol, propylene glycol, 1,3-butylene glycol, 1,4-butylene glycol, neopentyl glycol, hexalene glycol, or any combination thereof.

19. The electrolyte of claim 3, further comprising from about 0.5 wt. % to about 10 wt. % of a glyme, wherein the glyme is monoglyme, diglyme, triglyme, tetraglyme, pentaglyme, hexaglyme, or any combination thereof.

20. The electrolyte of claim 3, further comprising less than 1 wt. % of one or more additives selected from Sn, In, Ga, Al, Tl, Bi, Pb, Sb, Ag, Mn, Fe, or any combination thereof.

21. The electrolyte of claim 3, further comprising from 0.1 wt. % to 2 wt. % of acetic acid, sodium acetate, potassium acetate, or any combination thereof.

22. The electrolyte of claim 1, wherein the zinc halide electrochemical cell is a static zinc halide electrochemical cell.

23. The electrolyte of claim 1, wherein the zinc halide electrochemical cell is a flow zinc halide electrochemical cell.

24. The electrolyte of claim 1, wherein a zinc halide utilization in the electrolyte of the secondary zinc halide electrochemical cell is increased by about 5% to about 40% compared to an equivalent electrolyte in a secondary zinc halide electrochemical cell without the one or more zinc additives.

25. A secondary zinc halide battery comprising:
at least one electrochemical cell comprising at least one bipolar electrode and a zinc halide electrolyte,
wherein the bipolar electrode comprises a bipolar electrode plate having an anode surface on one side of the bipolar electrode plate and a cathode surface on another side of the bipolar electrode plate that is opposite the anode surface,
wherein the zinc halide electrolyte is in contact with the bipolar electrode plate, and
wherein the zinc halide electrolyte comprises:
from about 20 wt. % to about 50 wt. % of a zinc halide of formula ZnY₂ or any combination of zinc halides of formula ZnY₂, wherein Y is a halide selected from fluoride, chloride, bromide, iodide, or any combination thereof;
from about 30 wt. % to about 79 wt. % of H₂O; and
from about 0.5 wt. % to about 20 wt. % of one or more zinc additives, wherein the one or more zinc additives comprises a first zinc additive, wherein the first zinc additive is a salt that is not a zinc halide and comprises an anion with a van der Waals volume of greater than about 65 Å³.

26. The secondary zinc halide battery of claim 25, wherein the electrolyte further comprises:
from about 0.5 wt. % to about 15 wt. % of KBr; and
from about 0.5 wt. % to about 15 wt. % of KCl.

27. The secondary zinc halide battery of claim 26, wherein the electrolyte further comprises:
from about 0.05 wt. % to about 20 wt. % of one or more quaternary ammonium agents, wherein each quaternary ammonium agent is independently selected from a quaternary ammonium agent having a formula N⁺(R¹)(R²)(R³)(R⁴)X⁻, wherein R¹ is hydrogen or an alkyl group, R², R³, and R⁴ are each independently an alkyl group that is same or different from R¹, and X⁻ is chloride or bromide.

28. The secondary zinc halide battery of claim 25, wherein the electrolyte further comprises from about 0.2 wt. % to about 2.5 wt. % of DME-PEG.

29. The secondary zinc halide battery of claim 25, wherein the first zinc additive is zinc trifluoromethanesulfonate, zinc perfluorobutanesulfonate, zinc bis(trifluoromethane)sulfonimide, zinc methanosulfonate, zinc p-toluenesulfonate, zinc hexafluorophosphate, zinc tetrakis[3,5-bis(trifluoromethyl)phenyl]borate, or any combination thereof.

30. The secondary zinc halide battery of claim 25, wherein the one or more zinc additives further comprises a second zinc additive, wherein the second zinc additive is a salt that is not a zinc halide and comprises an anion with a van der Waals volume of smaller than about 65 Å³.

31. The secondary zinc halide battery of claim 25, wherein the electrolyte comprises from about 0.5 wt. % to about 15 wt. % of the second zinc additive.

32. The secondary zinc halide battery of claim 25, wherein secondary zinc halide battery is a static secondary zinc halide battery.

33. The secondary zinc halide battery of claim 25, wherein secondary zinc halide battery is a flow secondary zinc halide battery.

34. The secondary zinc halide battery of claim 25, wherein a zinc halide utilization in the electrolyte of each of the at least one electrochemical cell of the secondary zinc halide battery is increased by about 50% to about 40% compared to an equivalent electrolyte in an electrochemical cell of a secondary zinc halide battery without the one or more zinc additives.
